(19) United States
(12) Patent Application Publication
(10) Pub. No.: US 2010/0284290 A1
(43) Pub. Date: Nov. 11, 2010

(54) CONTEXT BASED DATA MEDIATION

(75) Inventor: Stephen Williams, Port Coquitlam (CA)

Correspondence Address: KNOBBE MARTENS OLSON & BEAR LLP, 2040 MAIN STREET, FOURTEENTH FLOOR, IRVINE, CA, 92614, US

(73) Assignee: AEGIS MOBILITY, INC., Vancouver (CA)

(21) Appl. No.: 12/757,840

(22) Filed: Apr. 9, 2010

Related U.S. Application Data
(60) Provisional application No. 61/168,145, filed on Apr. 9, 2009.

(51) Int. Cl. H04L 12/26; H04L 12/56

(52) U.S. Cl. 370/252; 370/389

(57) ABSTRACT

A communication environment includes of one or more subscriber terminals capable of receiving and transmitting data over a communication network via a communication management system. The communication management system receives mobile communication device context information and mobile communication device identification information from the mobile communication device. The communication management system then identifies data availability profiles reflective of a prior determination of mobile communication device availability to receive data communications according to context. The communication management system then implements data filtering rules corresponding to a current data availability profile.

### CROSS-REFERENCE TO RELATED APPLICATIONS

This application claims the benefit of U.S. Provisional Patent Application No. 61/168,145, entitled CONTEXT BASED DATA MEDIATION, and filed on Apr. 9, 2009, the entirety of which is incorporated by reference herein.

### BACKGROUND

In a packet switched data network it is very common practice to limit or regulate the flow of traffic using a data packet mediation device, such as a firewall, or a quality of service (“QoS”) router, such as a traffic shaping router. These data mediation devices use a mechanism for specifying rules to limit or regulate the flow of data packets through the data mediation device. For example, the data mediation device can utilize packet filters that describe the characteristics of data packets, a priority to be placed on any packets that matches the filter and an action, or actions, to be performed on any packet that matches the filter. For purposes of packet filtering, a packet can be described, or identified, using criteria such as source Internet Protocol (“IP”) address, destination IP address, direction (incoming and outgoing interfaces), protocol type (UDP, TCP, ESP, ICMP, etc.), and port number (for UDP and TCP based protocols).

Using the above criteria, a rule that specifies the following criteria: source=192.168.1.1, destination=0.0.0.0, direction=incoming, protocol=tcp, port=80 could be used to match all data packets coming into the data mediation device from a web browser (e.g., destination=0.0.0.0, direction=incoming, protocol=tcp, port=80) on machine corresponding to a source IP address of 192.168.1.1.

In a typical data filtering implementation, once the packets are recognized by the data mediation device using the filter, the data mediation device can implement a variety of actions for data packets matching the filtering rules. In one aspect, the data mediation device can change the priority of the packet. For example, the data mediation device can raise the priority of data packets to reduce delay (i.e., jitter in voice packet streams). Alternatively, the data mediation device can also lower the priority for time insensitive data, such as http (web browser) traffic. In another aspect, the data mediation device can perform other actions on the data packets including allowing the data packet to continue through the data mediation device, deny the data packet access to pass through the data mediation device, reject the data packet, drop the data packet, log the existence of the data packet, and the like.

Returning to the web browser example, in the event a data processing rule is specified that results in an action of denial of a data packet, the data mediation device typically returns a message indicating that the requested service is unavailable, thus denying service to the client. All other clients not corresponding to the destination IP address would not be subject to that particular filtering rule and may be able to reach the web server normally and receive service. The specific example described would be considered a static firewall; the rules never change unless they are changed manually.

In another embodiment, more sophisticated data mediation devices can introduce a reactive element to the rule sets. For example, the filter language can be extended to incorporate the concept of time, either absolute or relative, including start time, end time, and a maximum number of events in a specified period of time. The inclusion of reactive elements allows data mediation devices to have temporal limitations to the filtering rules. With reference again to the web browser example, a filtering rule may be configured such that the data mediation device will allow the web service to be available between the hours of 4 p.m. and 6 p.m. to client 192.168.1.1, but at all other times deny the service. A filter that utilized relative time might modify the web browser example to only allow 10 web browser sessions per hour, if the number of sessions exceeds 10 in the previous hour, then deny the session. These techniques are common in parental control products such as “Net Nanny” that limit the access and time a child spends on the Internet.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of one embodiment of a communication management environment including a communication management system and a number of mobile communication devices;

FIG. 2 is a block diagram illustrative of aspects of the communication management system of FIG. 1 in an embodiment of the communication management environment;

FIG. 3 is a block diagram illustrative of aspects of the mobile communication device of FIG. 1 in an embodiment of the communication management environment;

FIG. 4 is a block diagram of illustrating the transmission of mobile communication device context information by a mobile device and the processing by the communication management system;

FIGS. 5A and 5B are block diagrams of the communication management system of FIG. 1 illustrating the transmission of data requests by a mobile device and the processing by the communication management system of the data request;

FIGS. 6A and 6B are block diagrams of the communication management system of FIG. 1 illustrating the transmission of data by a computing device responsive to a data request by a mobile communication device and the processing by the communication management system of the data transmitted by the computing device;

FIGS. 7A-7E are flow diagrams illustrative of travel state context assessment algorithm implemented by a mobile communication device in providing mobile communication device context information to a communication management system;

FIGS. 8A and 8B are flow diagrams illustrative of a geospatial context assessment algorithm implemented by a mobile communication device in providing mobile communication context information to a communication management system;

FIG. 9 is a flow diagram illustrative of a communication management routine implemented by a communication management system for managing communications according to mobile communication device context information; and

FIG. 10 is a flow diagram illustrative of a mobile communication device information processing subroutine implemented by a communication management component.

### DETAILED DESCRIPTION

The present disclosure consists of one or more mobile communication devices capable of participating in data communications via a communication network. The mobile communication devices further determine, or otherwise collect, context information associated with a current context of the mobile communication device. Based on the context information and mobile communication identification information, a communication management system can process data communications between the mobile communication device and one or more computing devices. With reference to a specific embodiment, illustratively, the communication management system can filter data communications to or from the mobile communication device based on a mobile communication device context associated with motion, or other context in which data communication should be limited, or prevented altogether. Although aspects of the system will be described to the drawings, flow diagrams, screen interfaces, and specific examples, one skilled in the relevant art will appreciate that the disclosed embodiments are illustrative in nature. Accordingly, the disclosed embodiments should not be construed as limiting.

### System Overview

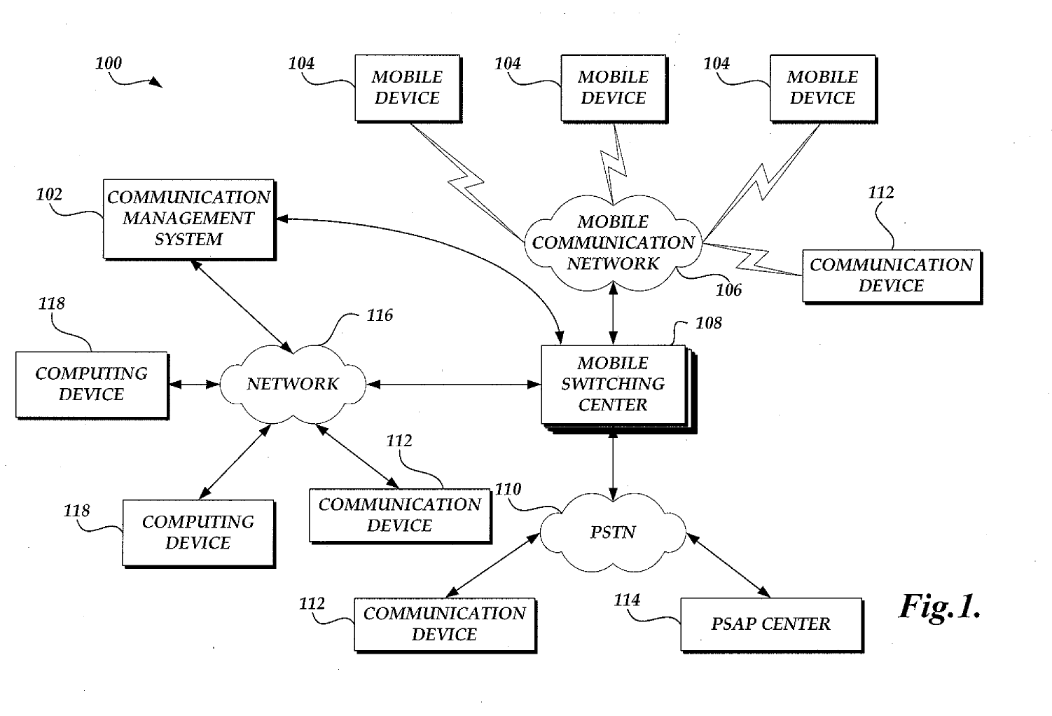

With reference now to FIG. 1, a block diagram illustrative of a communication management environment 100 for managing mobile communication device communications will be described. As illustrated in FIG. 1, the communication management environment 100 includes a communication management system 102 for processing data communications between a supported mobile communication device and one or more third party computing devices. The communication management system 102 maintains mobile communication device profiles that are provisioned to establish the availability for the mobile communication device to receive and transmit data via a communication network. As will also be described in greater detail below, in an illustrative embodiment, the communication management system 102 determines the availability of the mobile communication device to establish data communications asynchronously to any request to establish a communication channel.

To manage requested communications, the communication management system 102 communicates with corresponding subsystems responsible for establishing wireless communication channels, such as mobile switching center 108. The communication management system 102 can communicate with the mobile switching center 108 via a direct communication connection, a secure communication channel via a communication network, such as communication network 114, or via a public communication network.

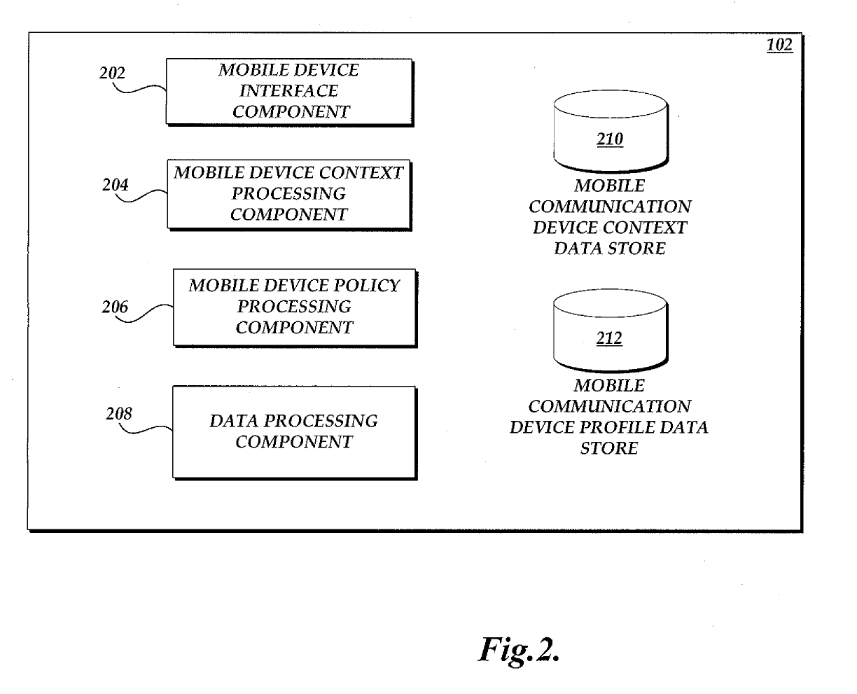

In an illustrative embodiment, the communication management system 102 provides data communication mitigation options in the event that the mobile communication device is unavailable to send or receive data communications. Still further, the communication management system 102 facilitates the generation of various graphical user interfaces for provisioning and/or managing mobile communication device profiles via computing devices 116. Illustrative components of the mobile communication management system 102 will be described in greater detail with regard to FIG. 2.

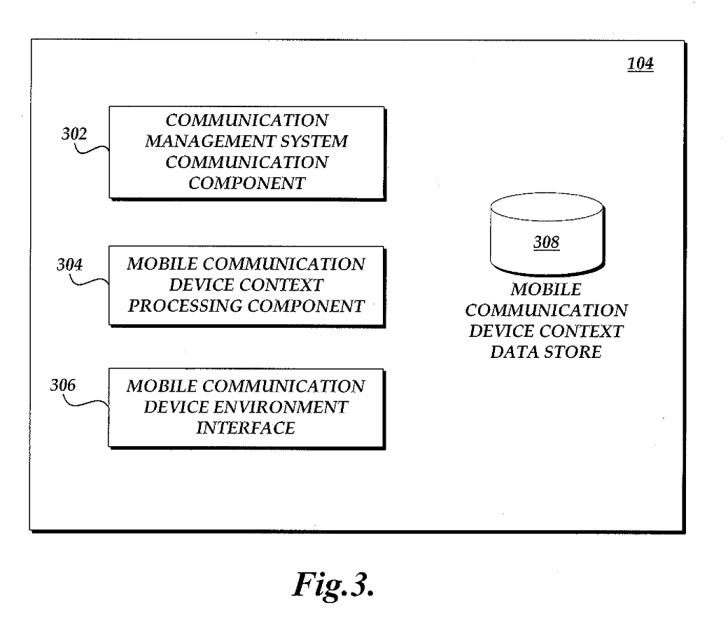

With continued reference to FIG. 1, the communication management environment 100 can include a number of mobile communication devices 104. The mobile communication devices 104 can correspond to wide variety of devices or components that are capable of initiating, receiving, or facilitating communications over a communication network including, but not limited to, personal computing devices, hand-held computing devices, integrated components for inclusion in computing devices, home electronics, appliances, vehicles, and/or machinery, mobile telephones, modems, personal digital assistants, laptop computers, gaming devices, and the like. In an illustrative embodiment, the mobile communication devices 104 include a wide variety of software and hardware components for establishing communications over one or more communication networks, including wireless or wired mobile communication networks 106. The mobile communication devices 104 can be associated with one or more users for managing data communications according mobile communication device contexts. Illustrative components of a mobile communication device will be described in greater detail with regard to FIG. 3.

With continuing reference to FIG. 1, an illustrative communication management environment 100 can include a number of additional components, systems, and/or subsystems for facilitating communications with the mobile communication devices 104 and/or the communication management system 102. The additional components can include one or more mobile switching centers 108 for establishing communications with the mobile communication devices 104 via the mobile communication network 106, such as a cellular radio access network, a wireless network based on the family of IEEE 802.11 technical standards (“WiFi”), a wireless network based on IEEE 802.16 standards (“WiMax”), and other wireless networks or wireless communication network standards. The operation of mobile communication networks, such as mobile communication network 106 are well known and will not be described in greater detail.

As illustrated in FIG. 1, the mobile switch center 108 includes interfaces for establishing various communications with via the communication network 116, such as the Internet, intranets, private networks, and point-to-point networks. In one example, the mobile switch center 108 can include interfaces for establishing communication channels with various communication devices 112, such as landline telephones, via a public switched telephone network (PSTN) 110. As will be described in greater detailed below, the mobile switch center 108 can facilitate communication channels between the mobile devices 104, the communication management system 102, and a PSAP center 114.

The mobile switch center 108 can also include interfaces for establishing communication channels with various communication network-based communication devices 112, such as a VoIP communication device. Still further, the mobile switch center 108 can include interfaces for establishing communication channels with a mobile-based communication device 112, such as another mobile communication device. For example, the communication devices 112 can correspond to a third-party mobile communication that establishes an audio communication channel with a mobile communication device 104. Accordingly, although communication network 116 is illustrated as a single communication network, one skilled in the relevant art will appreciate that the communication network can be made up of any number of public or private communication networks and/or network connections.

The various communication devices 112 can include the hardware and software components that facilitate the various modes of operation and communication, such as via wired and wireless communication networks. Additionally, the computing devices 118 can include various hardware and software components, such as a browser software application, that facilitate the generation of the graphical user interfaces for provisioning and managing mobile communication device profiles as will be described below.

One skilled in the relevant art will appreciate that the components and configurations provided in FIG. 1 are illustrative in nature. Accordingly, additional or alternative components and/or configurations, especially regarding the additional components, systems, and subsystems for facilitating communications may be utilized.

With reference now to FIG. 2, illustrative components for the communication management system 102 will be described. Although the operation of the various functions associated with the communication management system 102 will be described with regard to below subcomponents, one skilled in the relevant art will appreciate that the subcomponents are illustrative in nature. Accordingly, a communication management system 102 may include additional components or alternative components to facilitate one or more functions. Additionally, although the various subcomponents are illustrated as integrated into a communication management system 102, one or more of the components may be implemented in a distributed manner over a communication network and/or be implemented as a network service, e.g., a Web service.

As illustrated in FIG. 2, the communication management system 102 includes a mobile device interface component 202 for establishing communications with a mobile communication device 104. In an illustrative embodiment, the mobile device interface component 202 corresponds to a component for facilitating the bi-lateral transfer of data, such as mobile device context information, context assessment algorithms, etc., between the mobile communication device 104 and the communication management system 102. The mobile device communication component 202 can include software and hardware components necessary to establish one or more communication channels corresponding to various communication protocols such as Bluetooth, the family of IEEE 802.11 technical standards (“WiFi”), the IEEE 802.16 standards (“WiMax”), short message service (“SMS”), voice over IP (“VoIP”) as well as various generation cellular air interface protocols (including, but not limited to, air interface protocols based on CDMA, TDMA, GSM, WCDMA, CDMA2000, TD-SCDMA, WTDMA, LTE, OFDMA, and similar technologies).

The communication management system 102 can also include a mobile communication device context processing component 204 for determining the availability of a mobile communication device 104 for communication based on processing mobile communication device context information according to a mobile communication device profile. The mobile communication device context processing component 204 can execute various processes or algorithms for processing transmitted mobile communication device context information to determine mobile communication device availability to transmit or receive data. Additionally, the mobile communication device context processing component 204 can also manage the various context assessment processes or algorithms and updates to existing previously stored context assessment processes and algorithms that are transmitted and executed by the mobile communication devices 104. Still further, the mobile communication device context processing component 204 can further select one or more data filtering policies that have been specified for particular mobile communication device contexts, illustratively, in advance.

With continued reference to FIG. 2, the communication management system 102 can include a mobile communication device policy processing component 206 for processing the selected one or more data filtering policies and associated mobile communication device identifier information with the data filtering policies. Illustratively, the mobile communication device policy processing component 206 generates one or more data filtering rules applied by the communication management system 102 according to the selected policies. Additionally, the mobile communication device policy processing component 206 processes different types of mobile communication device identifiers, such as IP address, transport address, etc., that will be utilized to process incoming and outgoing data. The communication device policy processing component 206 can also manage existing data filtering rules based on a determined on changes in mobile communication device context. In this aspect, the communication device policy processing component 206 can merge, integrate, delete, or otherwise modify existing data filtering rules. Additionally, the communication device policy processing component 206 can generate updates for the existing data filtering rules to implement determined changes.

The communication management system 102 can further include a data processing component 208 for processing incoming and outgoing data according to the data filtering rules. In one embodiment, the data processing component 208 can inspect data packets and process the data packets according to the data filtering rules.

With continued reference to FIG. 2, the communication management system 102 can also include a mobile communication device context data store 210 for maintaining mobile communication device context information previously transmitted by the mobile communication devices 104 and/or for maintaining the mobile communication device context assessment algorithms utilized by the mobile communication devices to process inputs into mobile communication device context. In one embodiment, the mobile communication device context information may be accessible, or otherwise published, to other computing devices, network based services, or users via the communication network 114.

The communication management system 102 can further include a mobile communication device profile data store 212 for maintaining mobile communication device profiles. The mobile communication device profile data store 212 may be one or more databases configured to provide the communication processing component 204 required data to determine mobile communication device data filter templates based on mobile communication device context. As will be described in greater detail below, the mobile communication device profile data defines the availability of the mobile communication device 104 to receive or transmit data as a function of a current mobile communication device context.

With reference now to FIG. 3, illustrative components for the mobile communication device 104 will be described. Although the operation of the various functions associated with the mobile device 104 will be described with regard to below components, one skilled in the relevant art will appreciate that the components are illustrative in nature. Accordingly, a mobile device 104 may include additional components or alternative components to facilitate one or more functions. Additionally, although the various subcomponents are illustrated as integrated into a mobile device 104, one or more of the components may be implemented in a distributed matter over a communication network and/or be implemented as a network service, e.g., a Web service.

As illustrated in FIG. 3, the mobile device 104 includes a communication management system communication component 302 for facilitating communications with the communication management system 102. As described above with regard to the mobile device communication component 202 (FIG. 2), the communication management system communication component 302 facilitates the bi-lateral transfer of data between the mobile communication device 104 and the communication management system 102. One skilled in the relevant art will appreciate that the communication management system communication component 302 can include software and hardware components necessary to establish one or more communication channels corresponding to various communication protocols for establishing the bi-lateral communication channels. Moreover, although the communication management system communication component 302 is illustrated as a separate component, the functionality of the component may be integrated, or otherwise combined, with one or more hardware or software components utilized by the mobile communication device 104 to make communication channels (e.g., cellular communication channels or SMS communication channels as part of the designed function of the mobile device).

As will be described in greater detail below, the communication management system communication component 302 transmits current mobile device context information in accordance with the context assessment algorithms on the mobile device 104. Once a current mobile communication device context is established, the communication management system 302 can limit additional transmission of context information upon detection of a change in mobile communication context information. Additionally, in an alternative embodiment, the communication management system communication component 302 may also transmit, or otherwise publish, mobile communication device context information to additional recipients, such as communication network resources such as Web sites or network services, and/or to other peer destinations.

The mobile communication device 104 can also include a mobile communication device context information component 304 for processing a set of inputs corresponding to a mobile device environment to determine mobile device context information. Illustrative context assessment algorithms or processes for determining mobile device context information will be described in greater detail below. The mobile communication device contexts can identify or describe aspects of the mobile communication device 104, aspects of the mobile communication device environment, and/or aspects of the user associated with the mobile communication device. For example, the mobile communication device context corresponds to a determination of various states of movement/travel, such as in a non-transitory state, an in-transit state (including city/urban travel transit, highway transit, and in-flight transit states), a journey onset state, and a journey termination state. In another example, the mobile communication device context corresponds to a determination of whether a mobile communication device's present location is within a geospatial boundary, also referred to as geofencing, (including within the geospatial boundary, on a border of the geospatial boundary, or outside the geospatial boundary). One skilled in the relevant art will appreciate that the identified mobile device contexts are not exhaustive and that any number of additional mobile device contexts, or variations of the identified mobile communication device contexts, may also be defined for the mobile communication device 104. An illustrative system and methodologies for determining mobile communication device context or processing mobile communication device context information is described in co-pending and commonly assigned U.S. patent application Ser. No. 12/040,832, entitled MANAGEMENT OF MOBILE DEVICE COMMUNICATION SESSIONS TO REDUCE USER DISTRACTION, and filed on Feb. 29, 2008, the entirety of which is incorporated by reference herein.

With continued reference to FIG. 3, the mobile communication device 104 can also include a mobile communication device environment interface 306 for obtaining inputs corresponding to a mobile communication device environment. In an illustrative embodiment, the set of inputs can include information from one or more sensors such as a global position sensor (GPS) component or other location identification components, accelerometers, altimeters, compasses, gyroscopes, microphones, scales or other weight detection mechanisms, range finders, proximity sensors, gas or radiation detectors, electric current or electric induction detection, digital image sensors, thermometers and the like. Additionally, the set of inputs can correspond to information obtained from communication network based resource such as calendaring information, identity or contact information and the like.

In one embodiment, the set of inputs include information from sensors or information gathering components that are integrated or attached to the mobile computing device 104. In another embodiment, the set of inputs include information from external sensors or information gather components that provide the information via a communication channel, such as a hardwired connection or wireless connection (e.g., Bluetooth). Still further, in another embodiment, the set of inputs include information related to sensors or processed information from another device or article of manufacture associated with the mobile communication device. For example, the set of inputs can include information from a vehicle computer indicating information about the operation/condition of the vehicle and/or environmental information. Additional information from seat sensors may be able to inform that the remote end user is indeed a passenger and not a driver, and further, that seat belts are engaged. Still further, in another embodiment, the set of inputs include information from sensors that can be repurposed, such as through additional processing, to determine mobile communication device context information. For example, image data from a camera sensor or signal data from a transceiver chipset may be utilized as inputs to a context assessment algorithm to determine mobile communication device context. The above provided identification of the specific types of sensors is not exhaustive. Accordingly, additional or alternative sensors may be utilized to provide information for determining mobile communication device context information.

One skilled in the relevant art will appreciate that the set of inputs may be selected to correspond specifically to the particular algorithms utilized to calculate mobile communication device context. In one example, microphonic sensors may used for detecting high noise levels from the embedded device microphone and using this context to permit only high importance work related calls and data session requests that pertain to the current work function. In another example, the sensor information can corresponds to a determination whether a Bluetooth headset or alterative hands free device is active in accordance with a corporate policy and local jurisdiction law.

In still another example, proximity sensor information could be used to determine a context that the user is currently interacting in a specific manner with the mobile end device may enable specific call and data session management decisions to be critically enabled. In a further example, image data from a mobile device camera may be utilized via signal context assessment algorithms to determine the user's environment. In another example, user configurable keys/control sensor data can be utilized to customize mobile device context information, such as using soft keys, to register specific contexts provided by the mobile communication device user (e.g., “watch me,” “help,” etc.).

The mobile communication device 104 can further include a mobile communication device data store 308 for storing input information from the mobile communication device environment interface 306, context information generated by the mobile communication device processing component 304 and/or the various context assessment algorithms or processes used by the mobile communication device processing component to generate the mobile communication device context information.

### Mobile Communication Device Data Processing

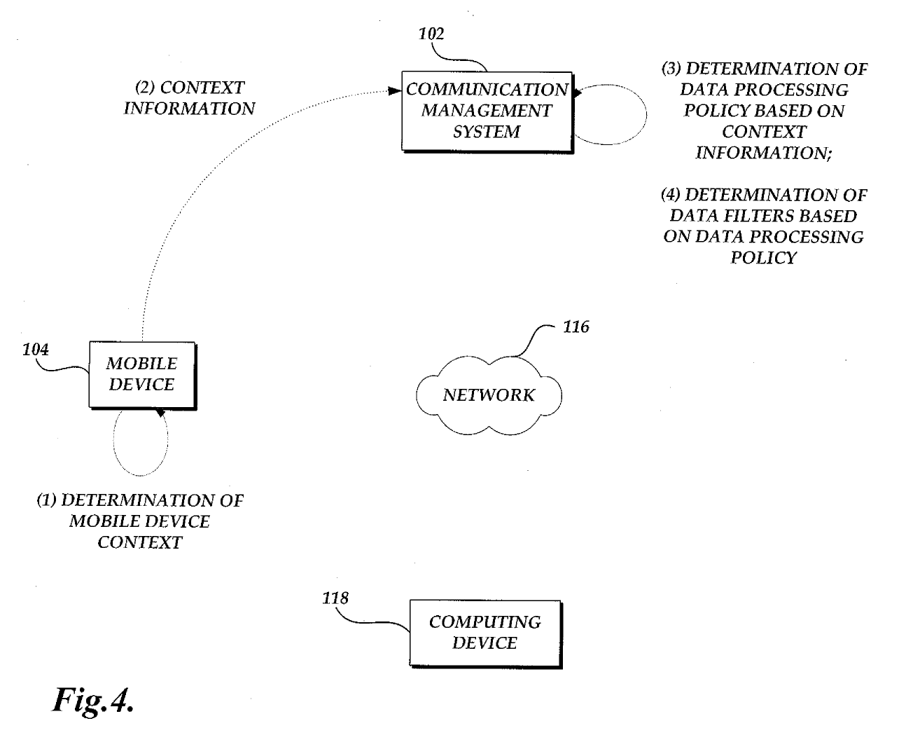

With reference now to FIGS. 4-6, the interaction between various components of the communication management environment 100 of FIG. 1 will be illustrated. For purposes of the example, however, the illustration has been simplified such that many of the systems, subsystems, and components utilized to facilitate communications are not shown. One skilled in the relevant art will appreciate that such components or subcomponents can be utilized and that additional interactions would accordingly occur without departing from the spirit and scope of the present invention.

With reference now to FIG. 4, an embodiment related to the transmission of mobile communication device context information by a mobile communication device 104 and the processing by the communication management system 102 will be described. For purposes of the illustrative example, a particular mobile computing device 104 has registered with a communication management service that provides the communication management system 102. Additionally, a user of the mobile device 104 has provisioned a mobile communication device profile that identifies the availability of the mobile communication device as a function of mobile communication device contexts and third party identification information. Alternatively, some portion the mobile communication device profile may be pre-provisioned for the user and/or automatically set by an administrator, such as a service provider.

As illustrated in FIG. 4, during the operation of the mobile communication device 104, or during an initialization of the mobile communication device, the mobile communication device interface component 306 obtains a set of inputs corresponding to the mobile communication device environment. The set of inputs are processed by the mobile communication device context processing component 304 to generate mobile communication device context information. The communication management system communication component 302 than transmits the mobile communication device context information to the communication management system 102 as appropriate. Specifically, to reduce power consumption and/or bandwidth consumption, the communication management system communication component 302 may limit the transmission of mobile communication device context information for the initialization of a mobile communication device context, a detection of a change in mobile communication device context and/or for the re-establishment of a mobile communication device context.

Upon receipt of the context information, the mobile device interface component 202 transmits the context and identification information to the mobile communication device context processing component 204 for processing. As previously described, the identification information can include IP address, transport address, and any other information utilized to associate a particular mobile communication device with a data filtering policy. Illustratively, a policy can have a one-to-one match with mobile device identification information. Alternatively, a policy can have a one-to-many match such that a particular policy can apply to multiple mobile communication devices 104. For example, a particular policy may apply to all mobile communication devices 104 provided by an organization (such as a company or service provider) or associated with a family.

With continued reference to FIG. 4, the mobile communication device context processing component 204 obtains a corresponding, or applicable, mobile communication device profile from the mobile communication device profile data store 212. The communication processing component 204 may utilize the selected mobile communication device profile to determine mobile communication device data availability from the context information. Based on the mobile communication device profile selected according to the context, the mobile communication device policy processing component 206 determines data filters corresponding to the policy (and specified actions). In an illustrative embodiment, the mobile communication policy processing component 206 can generate a new set of data filtering rules corresponding to the selected policies that can be applied by the data processing component 208. Additionally, in the event that data filtering rules already exist for the mobile communication device, the mobile communication policy processing component 206 can compare data filtering rules corresponding to the current policy against the previously established data filtering rules. The mobile communication policy processing component 206 can then generate an update that modifies or supplements the existing data filtering rules.

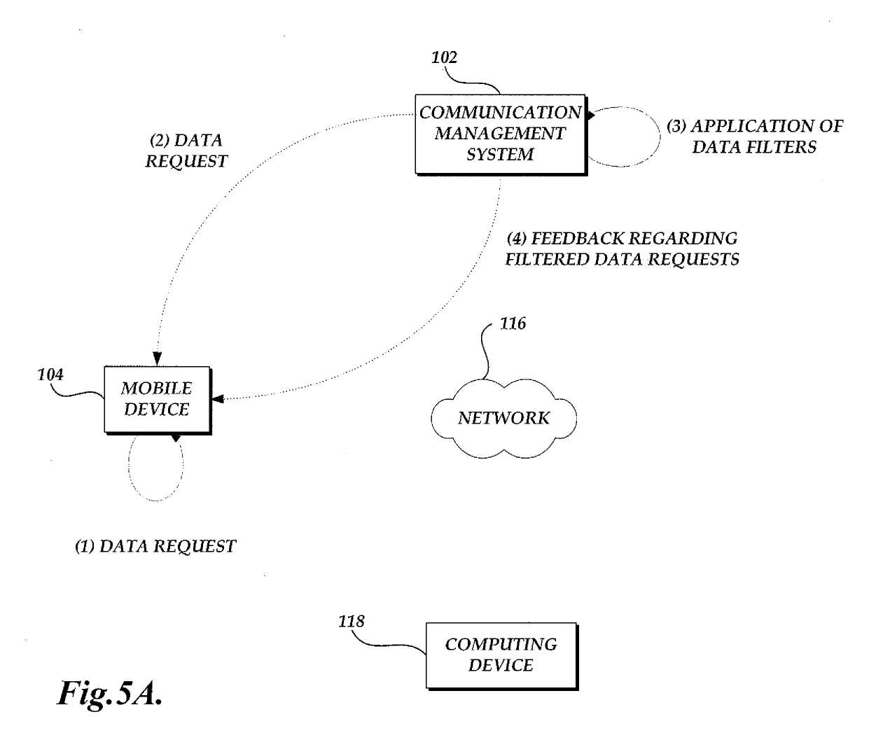

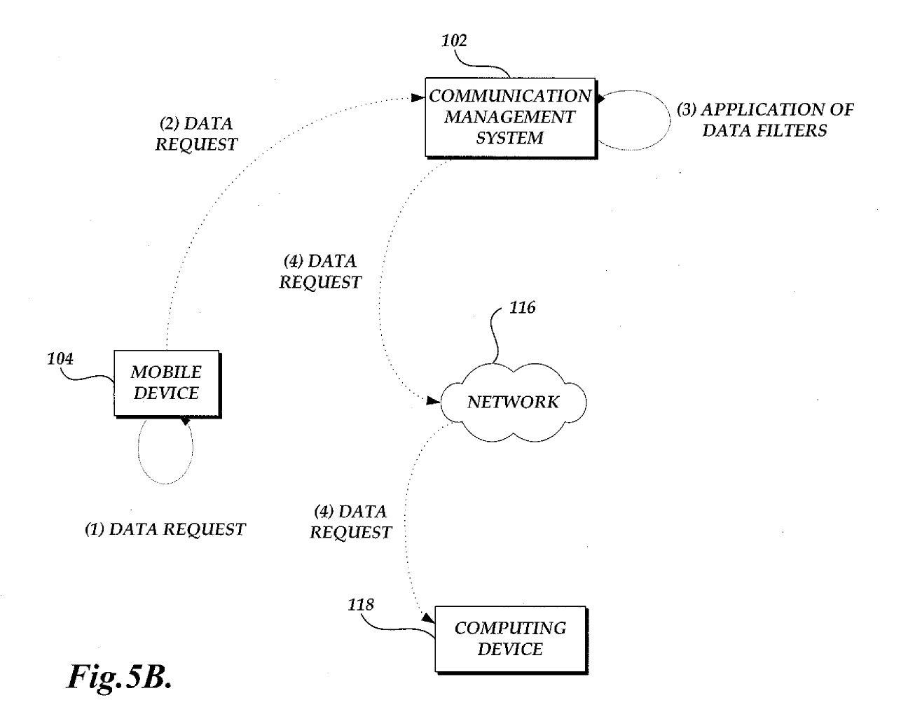

With reference now to FIGS. 5A and 5B, embodiments for processing data requests transmitted by a mobile communication device 104 will be described. With reference to FIG. 5A, the mobile communication device 104 can initiate a data request that is intended to be transmitted via the communication management system 102. Illustratively, the data request can be generated by software applications executed by the mobile communication device 104, such as browser software application, telephony applications, or other software applications or operating system functionality. Based on the data request, the communication management system 102 processes the data request in the form of data packets. Illustratively, the communication management system 102 inspects data packets and attempts to extras identification information for purposes of determining the applicability of data filtering rules. The identification information can include IP address information (destination, source, etc.), transport information, mobile identification number (“MIN”), international mobile subscriber identity (“IMSI”), network access identifier (“NAI”), session initiated protocol (“SIP”) address, electronic mail address, uniform resource identifier (“URI”), or other abstraction information that is transmitted in a data request.

In the embodiment illustrated in FIG. 5A, the communication management system 102 has implemented a data filtering policy (based on context) that affects the data packets associated with the data request. Accordingly, the data packets are filtered (e.g., denied, rejected, dropped, etc.) by the data processing component 208 of the communication management system 102. In an illustrative embodiment, the communication management system 102 may also provide some type of feedback mechanism indicative of the filtered data requests, such as notifications to the mobile communication device 104. Additionally, the communication management system 102 can also mitigate communications, such as by caching data packets or trying to queue the request to retry at a later time. For example, if the data request corresponds to a VoIP call, the communication management system 102 may try cache the data packets and attempt another “call” at a later time.

Referring now to FIG. 5B, in an alternative embodiment to FIG. 5A, based on the data request, the communication management system 102 processes the data request in the form of data packets and has implemented a data filtering policy (based on context) that does not affect the data packets associated with the data request. Accordingly, the data packets are not filtered by the data processing component 208 of the communication management system 102 and transmitted along the communication network 116.

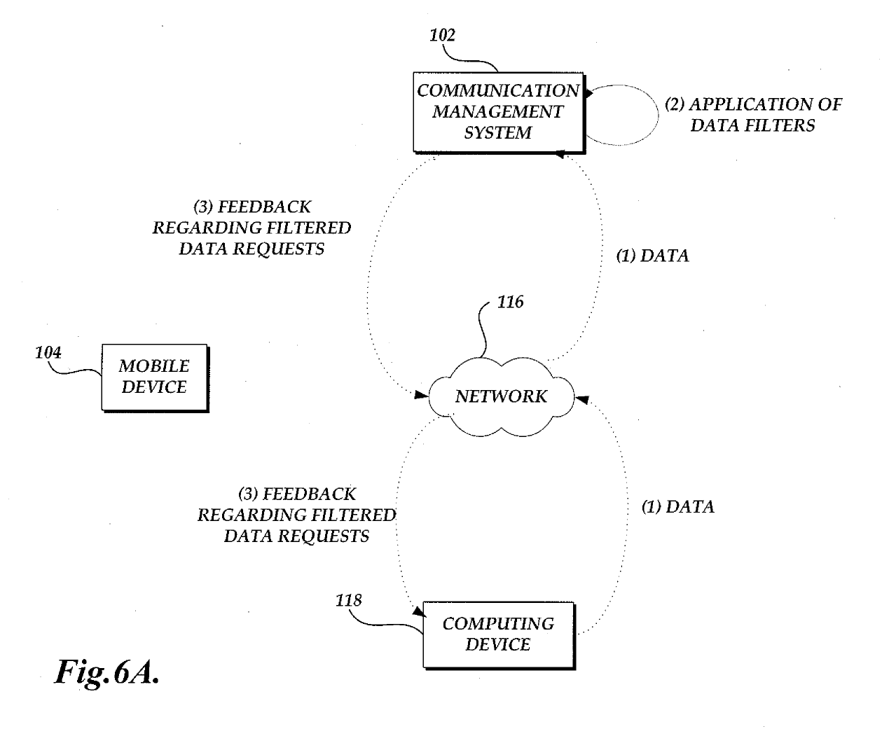

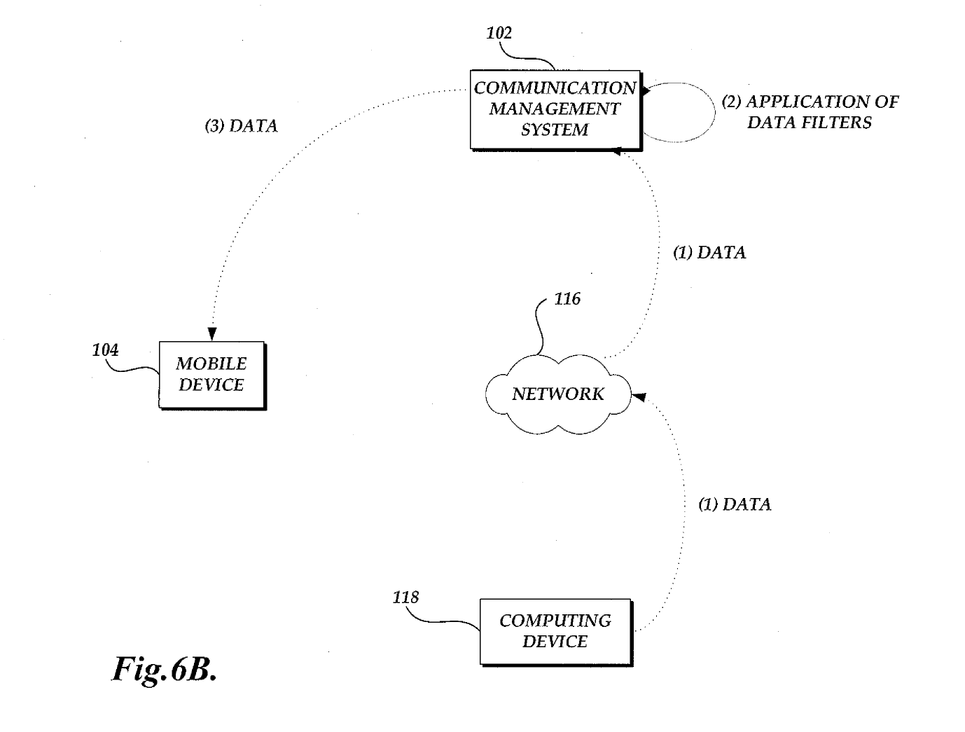

With reference now to FIGS. 6A and 6B, embodiments for processing data requests transmitted to a mobile communication device 104 will be described. With reference to FIG. 6A, a computing device 118, such as a server computing device or peer computing device, can initiate a data request that is intended to be transmitted via the communication management system 102 to the mobile communication device 104. Illustratively, the data request can be responsive to a request generated by software applications executed by the mobile communication device 104, such as browser software application, telephony applications, or other software applications or operating system functionality. Alternatively, the data request can be initiated by the computing device 118. Based on the data request, the communication management system 102 processes the data request in the form of data packets. As discussed above with regard to FIG. 5A, the data processing component 208 can utilize a wide variety of identification information in determining the applicability of data processing information.

In the embodiment illustrated in FIG. 6A, the communication management system 102 has implemented a data filtering policy (based on context) that affects the data packets associated with the data request. Accordingly, the data packets are filtered (e.g., denied, rejected, dropped, etc.) by the data processing component 208 of the communication management system 102. In an illustrative embodiment, the communication management system 102 may also provide some type of feedback mechanism indicative of the filtered data requests, such as notifications to the computing device 118. Additionally, the communication management system 102 can also mitigate communications, such as by caching data packets or trying to queue the request to retry at a later time. For example, if the data request corresponds to a VoIP call, the communication management system 102 may try cache the data packets and attempt another “call” to the mobile communication device 108 at a later time. In another example, the communication management component 102 can forward a VoIP call to a messaging service in the event the data packet transmissions are mitigated.

Referring now to FIG. 6B, in an alternative embodiment to FIG. 6A, based on the data request, the communication management system 102 processes the data request in the form of data packets and has implemented a data filtering policy (based on context) that does not affect the data packets associated with the data request. Accordingly, the data packets are not filtered by the data processing component 208 of the communication management system 102 and transmitted along the communication network 116 to the mobile communication device 108.

### Mobile Device Context Assessment Algorithms

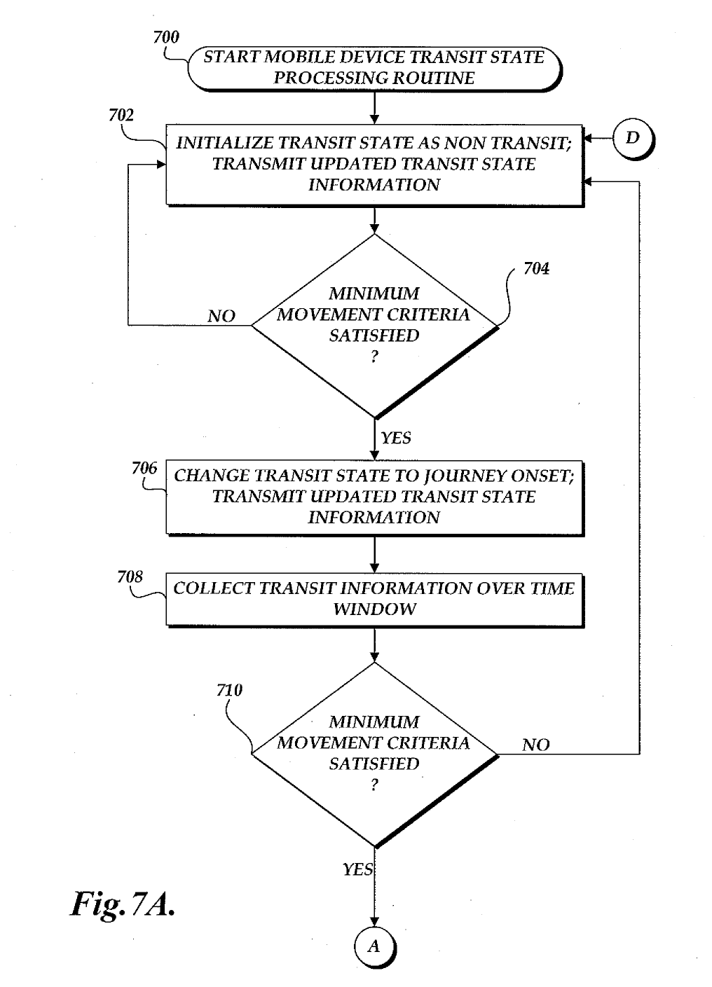

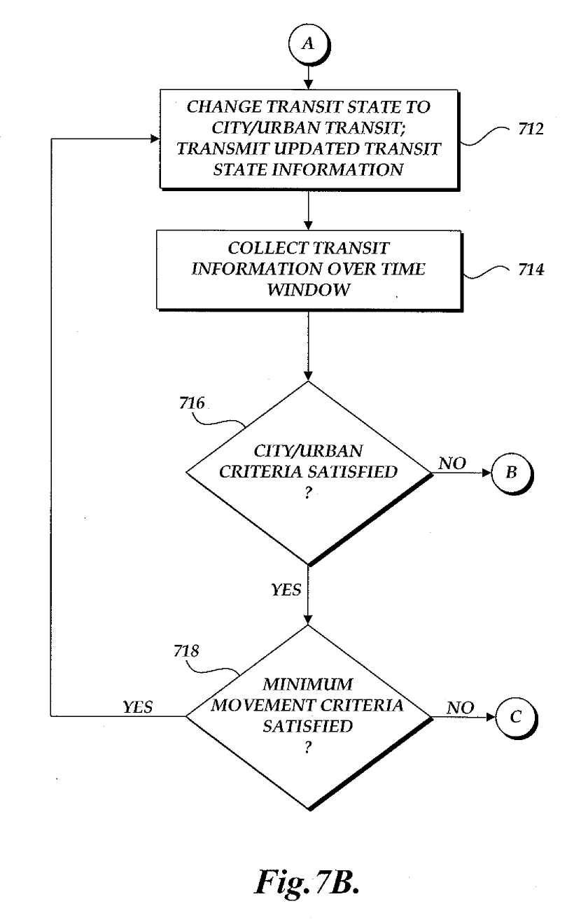

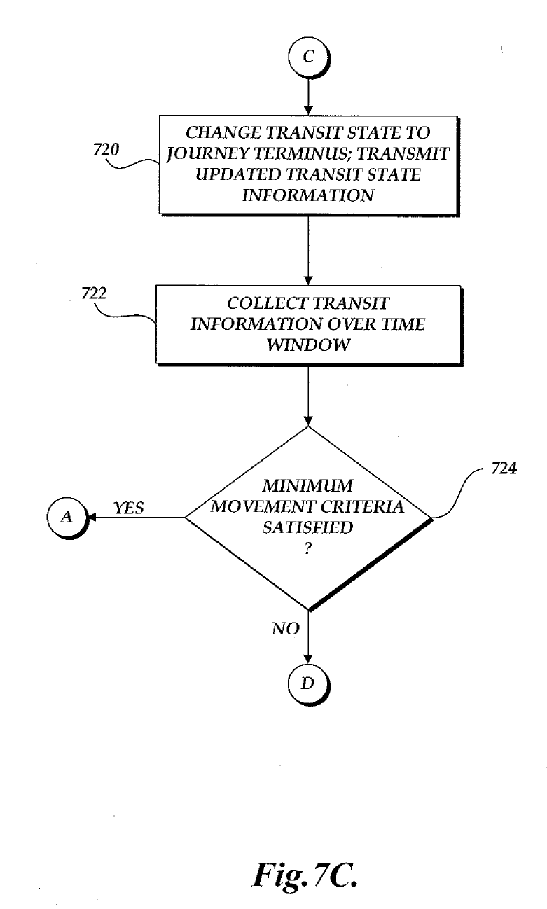

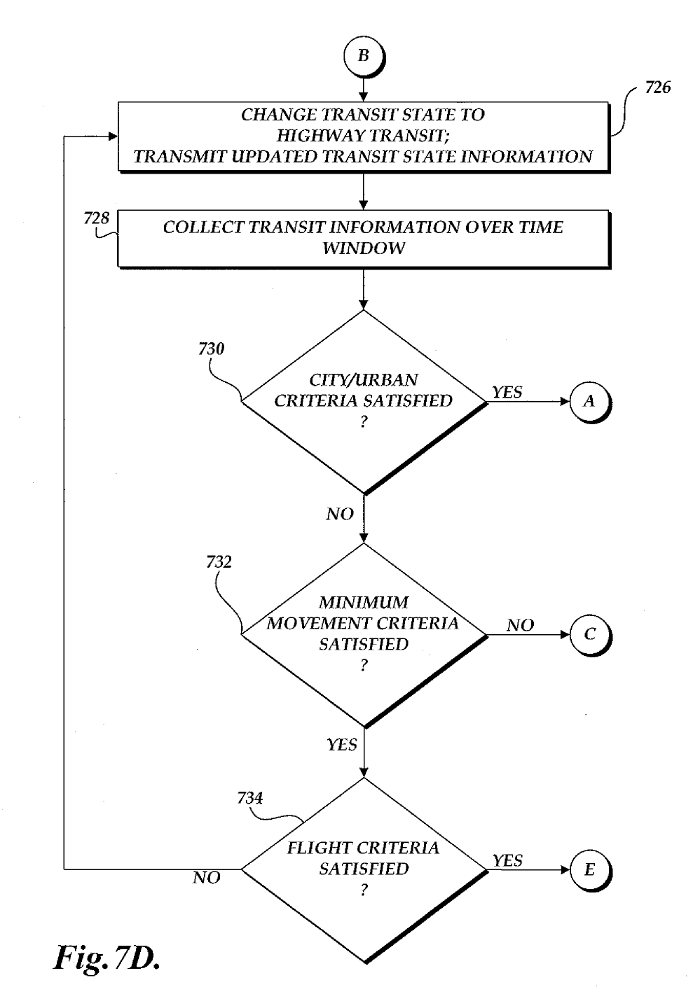

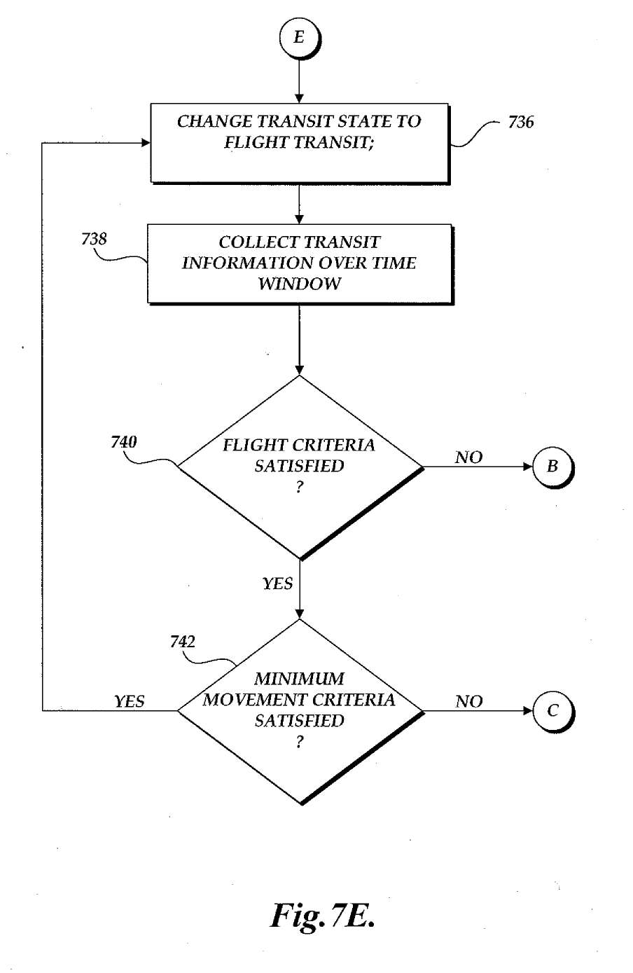

With reference now to FIGS. 7A-7E, an illustrative routine 1200 implemented by the mobile communication device context processing component 304 for determining context information of a mobile communication device 104 will be described. As described above, the mobile communication device context can correspond to a determination of a specific transit state indicative of a current mobile communication device environment. The availability for a data communications may be based on the determined transit state and the appropriate mobile communication device profile. With reference to FIG. 7A, at block 702, the routine 700 begins with the initialization of the transit state to non-transit by the mobile communication device context processing component 304. In an illustrative embodiment, the non transit state is a first state indicative of when the mobile communication device 104 is powered on or begins tracking transit state. The initialization of the transit state to non transit may be transmitted to the communication management system 102 or may be assumed as the starting context for the mobile communication device 104. At decision block 704, a test is conducted to determine whether minimum movement criteria have been satisfied based on processing the set of inputs. For example, the test can correspond to a review of velocity input(s) and distance traveled input(s) to determine whether the input values exceed a minimum threshold.

Velocity and distance information can be obtained by the mobile communication device through a variety of sensors and/or components designed to generate or calculate such information. Examples include, but are not limited to, GPS devices/components, accelerometers, navigational equipment, and the like. As previously described, the sensors and/or components may be integrated into the mobile communication device 104 or may be separate components (e.g., a car navigation system) that provide the input information via a wired or wireless connection.

In another example, the velocity and distance information may be calculated by the mobile communication device 104 through by the utilization of recognizable or detectable objects. In accordance with this example, the mobile communication device 104 receives signals generated by fixed transmitters, such as cellular communications base stations or WiFi wireless nodes, which generally include some identification information specific to the particular transmitter, such as an SSID for a wireless node. As a mobile communication device 104 travels, signals from specific transmitters are detected when the mobile communication device is within range of the transmitter and no longer detected when the mobile communication device is beyond the range of the transmitter. For known communication ranges of transmitters, such as WiFi wireless nodes, velocity and distance traveled information may be calculated based on monitoring time from the detection of a signal from a transmitter to loss of the signal. Additionally, the detection of the signal from the transmitter would not require registration with the transmitter and could still be practiced with transmitters that restrict access, such as through encrypted transmissions.

If the minimum movement criteria have not been satisfied, it is assumed that the mobile communication device (considering its environment) is still in a non-transit state and the routine 700 returns to block 702. The routine 700 may continue to loop through this portion for any amount of time.

Alternatively, if the minimum movement criteria have been satisfied, it is assumed that the mobile communication device 104 (considering its environment) is in motion, and at block 706, the transit state is changed to a “journey onset state.” Because the transit state has changed, the mobile communication device 104 may transmit updated context information to the communication management component 102 indicative of the change in transit state to a journey onset state. At block 708, the mobile communication device context processing component 304 enters an observation window for collecting the various inputs over a period of time. The observation window can be configured such that the mobile communication device 104 collects a fixed number of sets as defined by an information collection interval over a time period. Each time a set of inputs is collected a counter is decremented and the process continues until the targeted number of sets on inputs have been collected (e.g., the counter is decremented to a value of “0”). Additionally, if the mobile communication device environment interface 306 is currently not receiving inputs, or otherwise not accepting inputs, the mobile communication device 104 may enter a lower power consumption mode in which one or more components of the mobile communication device 104 become inactive or enter in a low power consumption mode of operation. In turn, the mobile communication device 104 then powers up, or wakes up, at the next information collection interval. The specific information collection interval implemented by the mobile communication device context processing component 304 may be dependent on the granularity of the sensor information, the amount of input information that should be collected for a given transit state, and/or the likelihood of a potential change in transit state. For example, a longer collection interval can be set for transit states in which variations in the set of inputs is not expected (e.g. a highway transit state) to further conserve mobile communication device power.

Upon the expiration of the time window, at decision block 710, a test is conducted to determine whether minimum movement criteria have been satisfied based on processing the set on inputs. If the minimum movement criteria have not been satisfied, the mobile communication device 104 is determined to be no longer in motion and the routine 700 returns to block 702 to a “non transit” travel state (described above). Because the transit state has changed, the mobile communication device 104 may transmit updated context information to the communication management component 102 indicative of the change in transit state back to a non transit state.

With reference now to FIG. 7B, alternatively, if at decision block 710 (FIG. 7A), the minimum movement criteria have been satisfied, at block 712, the mobile communication device 104 is determined to be in motion and the transit state is changed to a “city/urban” transit state. In an illustrative embodiment, the city/urban transit state can correspond to the driving conditions experienced in city or urban areas in which there are frequent stops and wide changes in velocity. Again, because the transit state has changed, the mobile communication device 104 may transmit updated context information to the communication management component 102 indicative of the change in transit state back to a non transit state. At block 714, the mobile communication device context processing component 304 enters an observation window that defines a set of intervals for collecting multiple sets of inputs over a period of time. In a city/urban transmit state, the collection interval for receiving each set of inputs may be configured to be shorter because of the potential for greater variances in the information from set of inputs.

At decision blocks 716-718, the mobile communication device context processing component 304 processes the collected input data to determine whether the mobile communication device 104 should remain in its current city/urban transit state, whether the mobile communication device has reached a terminus state, or whether the transit state is more indicative of another transit state typically indicative of highway travel. The collected information can include velocity, bearing, and distance traveled information. Additionally, the collected information can include processed velocity, bearing and distance traveled information, referred to as variance information, that indicate variances and/or rates of variance in the velocity, bearing and distance traveled over each of the collection intervals in the observed time window.

At decision block 716, a test is conducted to determine criteria indicative of city/urban transit state have been satisfied. The criteria indicative of city/urban transit state can correspond to consideration of variance thresholds for velocity, distance traveled and bearing that are indicative of patterns of city/urban travel. For example, velocity variances for a city/urban transit state may be indicative of a collection of inputs at a time in which a vehicle is stopped (e.g., at a street light) and another collection when the vehicle is traveling at a higher velocity. The thresholds may be determined by observed driving behavior, set by an administrator or set by a particular user. If the criteria indicative of city/urban transit state have not been satisfied, the mobile communication device context processing component 304 determines that the mobile communication device 104 is not likely in a city/urban driving embodiment and moves to block 726, which will be described in greater detail below. Alternatively, if the criteria indicative of city/urban transit state have been satisfied, the mobile communication device context processing component 304 determines that the mobile communication device 104 should either remain in a city/urban travel state or has reached a terminus. Accordingly, at decision block 718, a test is conducted to determine whether minimum movement criteria have been satisfied based on processing the set on inputs. If the minimum movement criteria have not been satisfied, the mobile communication device 104 is determined to be no longer in motion and the routine 700 proceeds to block 720 (FIG. 7C). Alternatively, if the minimum movement criteria have been satisfied, the routine 700 returns to block 712. In this instance, however, the mobile communication device 104 does not need to transmit context information to the communication management component 102 because the transit state has not changed.

With reference now to FIG. 7C, at block 720, the transit state of the mobile communication device is changed to a “journey terminus” transit state. In an illustrative embodiment, the journey terminus transit state can correspond to the completion of the initial travel. As previously described, because the transit state has changed, the mobile communication device 104 may transmit updated context information to the communication management component 102 indicative of the change in transit state. At block 722, the mobile communication device context processing component 304 enters an observation window in which a collection interval may be set to a shorter time period because of the expectation for a higher variance between the sets of inputs at each collection interval.

Upon the completion of the observation window, the mobile communication device context processing component 304 will determine whether the mobile communication device has re-entered a travel state (e.g., after a temporary stop) or has entered a non-transitory state (e.g., at home or at the office). Accordingly, at decision block 724, a test is conducted to determine whether a minimum movement has been detected based on the set on inputs. If minimum movement has not been detected, the mobile communication device 104 is determined to be no longer in motion. Accordingly, the transit state is changed to “non transitory” at block 702 (FIG. 7A). Alternatively, if a minimum movement has been detected based on the set on inputs, the mobile communication device 104 is determined to be in transit again and the routine 700 proceed to block 712 (FIG. 7B) in which the transit state is changed to city/urban transit state. In both decision alternatives, the mobile communication device 104 transmits updated context information to the communication management component 102 indicative of the change in transit state.

With reference now to FIG. 7D, if at decision block 716 (FIG. 7B), the criteria indicative of city/urban transit state were not satisfied, the mobile communication device context processing component 304 determines that the mobile communication device is a highway transit state, indicative of highway travel. Accordingly, at block 726, the transit state is changed to a “highway” traveled state and the mobile communication device 104 transmits updated context information to the communication management component 102 indicative of the change in transit state. At block 728, the mobile communication device context processing component 304 enters an observation window in which a collection interval may be set to a longer time period because of the expectation for a lower variance between the sets of inputs at each collection interval. When the mobile communication device 104 is a highway transit state, it can transition to a terminus state (e.g., indicative of a completion of travel), revert back to a city/urban transit state or remain in a highway transit state. Additionally, in an optional embodiment, the mobile communication device context processing component 304 can determine that the mobile communication device 104 is a flight state indicative of airplane travel. Accordingly, as will be illustrated in FIG. 7D, the mobile communication device context processing component 304 can also reach an “in flight” transit state from the highway traveled state. In all the decision alternatives involving a change in transition state, the mobile communication device 104 transmits updated context information to the communication management component 102 indicative of the change in transit state.

At decision block 730, a test is conducted to again determine whether criteria indicative of city/urban transit state has been satisfied. If the city criteria indicative of city/urban transit state has been satisfied, the mobile communication device context processing component 304 determines that the mobile communication device 104 should revert back to a city/urban travel state and the routine 700 returns to block 712 (FIG. 7B). Alternatively, if the criteria indicative of city/urban transit state has not been satisfied, the mobile communication device context processing component 304 determines that the mobile communication device 104 should either remain in the highway transit state, move to a journey terminus state, or move to an in flight state. Accordingly, at decision block 732, a test is conducted to determine whether a minimum movement has been detected based on the set on inputs. If the minimum movement has not been detected based on the set on inputs, the mobile communication device 104 is determined to be no longer in motion and the routine 700 proceeds to block 720 (FIG. 7C).

If, however, at decision block 732, the minimum movement has been detected based on the set on inputs, at decision block 734, a test is then conducted to determine whether criteria indicative of an in-flight transit state has been satisfied. In an illustrative embodiment, criteria indicative of an in-flight transit state can correspond to consideration of variance thresholds for velocity, distance traveled and bearing that are indicative of patterns of air travel. The criteria may also include consideration of information from altimeters or the like. The thresholds may be determined by observed driving behavior, set by an administrator or set by a particular user. If the criteria indicative of an in-flight transit state has not been satisfied, the mobile communication device context processing component 304 determines that the mobile communication device should remain in a highway transit state and the routine 700 returns to block 726.

With reference now to FIG. 7E, if the criteria indicative of an in-flight transit state has been satisfied, the mobile communication device context processing component 304 determines that the mobile communication device is in flight. Accordingly, at block 736, the transit state is changed to an “in flight” transit state. At block 738, the mobile communication device context processing component 304 enters an observation window for collecting the various inputs over a period of time, which may be a longer time period. At decision block 730, a test is conducted to determine whether is conducted to determine whether one or more in flight distance variances have been exceeded. If the criteria indicative of an in-flight transit state has not been satisfied, the mobile communication device context processing component 304 determines that the mobile communication device 104 should revert back to a highway travel state and the routine 700 returns to block 726 (FIG. 7D). Alternatively, if the criteria indicative of an in-flight transit state has been satisfied, the mobile communication device context processing component 304 determines that the mobile communication device 104 should either remain in the in flight distance transit state or move to a journey terminus state. Accordingly, at decision block 740, a test is conducted to determine whether a minimum movement has been detected based on the set on inputs. If the minimum movement has not been detected based on the set on inputs, the mobile communication device 104 is determined to be no longer in motion and the routine 700 proceeds to block 720 (FIG. 7C). Alternatively, if minimum movement has been detected based on the set of inputs, the routine 700 remains in an in-flight transit state and the routine 700 returns to block 736. In all the decision alternatives involving a change in transition state, the mobile communication device 104 transmits updated context information to the communication management component 102 indicative of the change in transit state.

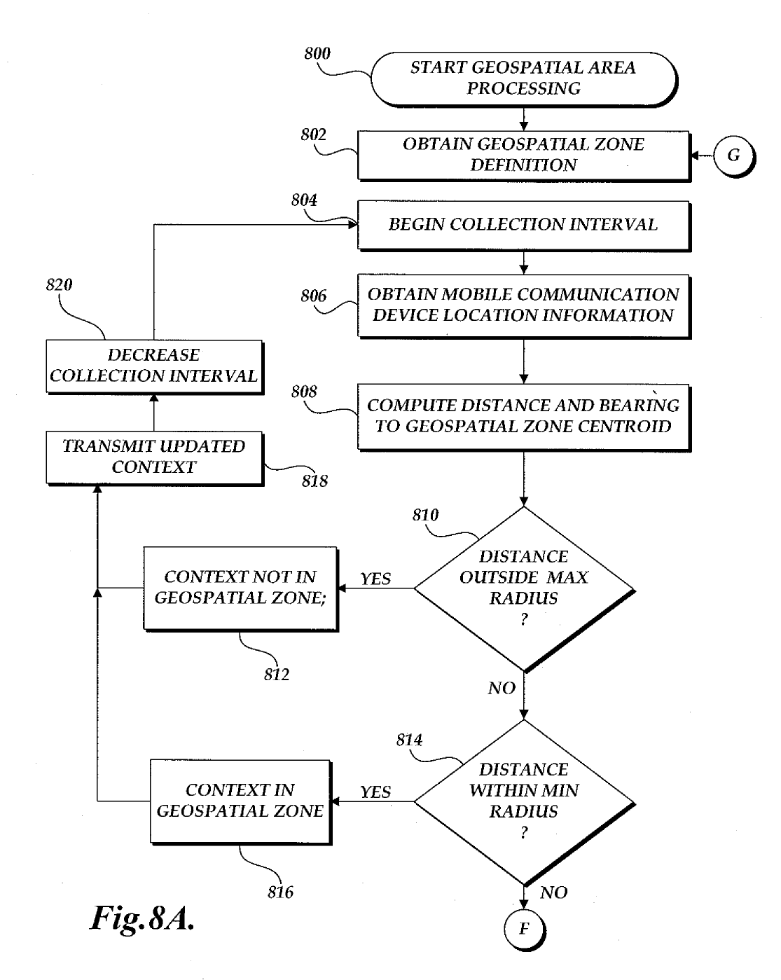

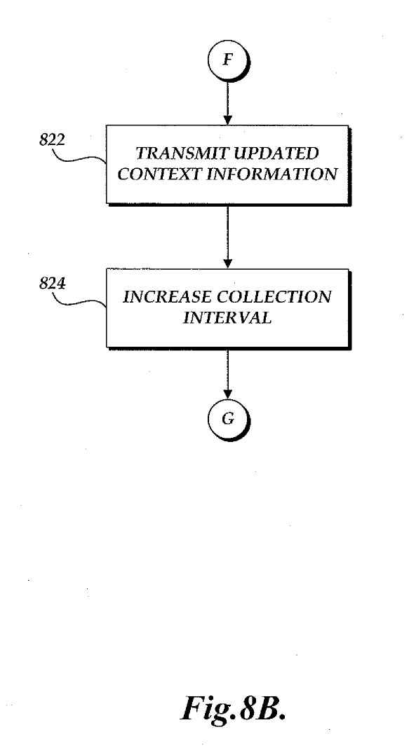

With reference now to FIGS. 8A and 8B, a routine 800 implemented by the mobile communication device context processing component 304 for determining mobile communication device geospatial context information will be described. In an illustrative embodiment, geospatial information may be defined for a geographic region. The geospatial information can include a centroid, which corresponds to an approximation of the geospatial region's central position. The centroid can be defined in terms of a longitude and latitude, x and y coordinates in a grid-type layout or other position coordinates. The geospatial information can also include a minimum radius distance that corresponds to a minimum radius that is within all boundaries of the geospatial region. The geospatial information can further include a maximum radius that corresponds to a maximum radius that is beyond all boundaries of the geospatial region. One skilled in the relevant art will appreciate that the contours of boundaries of a geospatial region can be defined in terms of a radius distance plus bearing from the centroid.

With reference to FIG. 8A, at block 802, the mobile communication device context processing component 304 obtains the geospatial region definitions from the mobile communication device context data store 308. The geospatial region definitions may be stored and maintained in a variety of formats and storage media. Additionally, the geospatial region definitions may be prioritized in terms of order of processing by the mobile communication device 104. At block 804, the mobile communication device environment interface 306 begins a collection window in which a geospatial zone definition is evaluated to determine whether the mobile communication device 104 is within the zone. As described above with regard to transit state context assessment algorithms, the observation window can be configured such that the mobile communication device 104 collects a fixed number of sets as defined by an information collection interval over a time period. Each time a set of inputs is collected a counter is decremented and the process continues until the targeted number of sets on inputs have been collected (e.g., the counter is decremented to a value of “0”). Additionally, if the mobile communication device environment interface 306 is currently not receiving inputs, or otherwise not accepting inputs, the mobile communication device 104 may enter a lower power consumption mode in which one or more components of the mobile communication device 104 become inactive or enter in a low power consumption mode of operation. In turn, the mobile communication device 104 then powers up, or wakes up, at the next information collection interval. The specific information collection interval implemented by the mobile communication device context processing component 304 may be dependent on the granularity of the sensor information, the amount of input information that should be collected for a given transit state, and/or the likelihood of a potential change in transit state. For example, a longer collection interval can be set for transit states in which variations in the set of inputs is not expected to further conserve mobile communication device power.

At block 806, the mobile communication device context processing component 304 obtains mobile communication location information. In an illustrative embodiment, the mobile communication device environment interface 306 can obtain various sensor information indicative of a location or relative location of the mobile communication device. For example, the mobile communication device environment interface 306 can obtain GPS information from an attached GPS component or via wireless communication from another GPS component. In another example, the mobile communication device environment interface 306 can interface with a vehicle's navigation system to obtain location information. In still another example, the mobile communication device environment interface 306 can interface with wireless communication equipment, such as cellular base stations, wireless network nodes (e.g., WiFi and WiMax network nodes), and obtain location information. Additionally, the sensor information can include accelerometers and compass information that facilitates a bearing or direction of the mobile communication device.

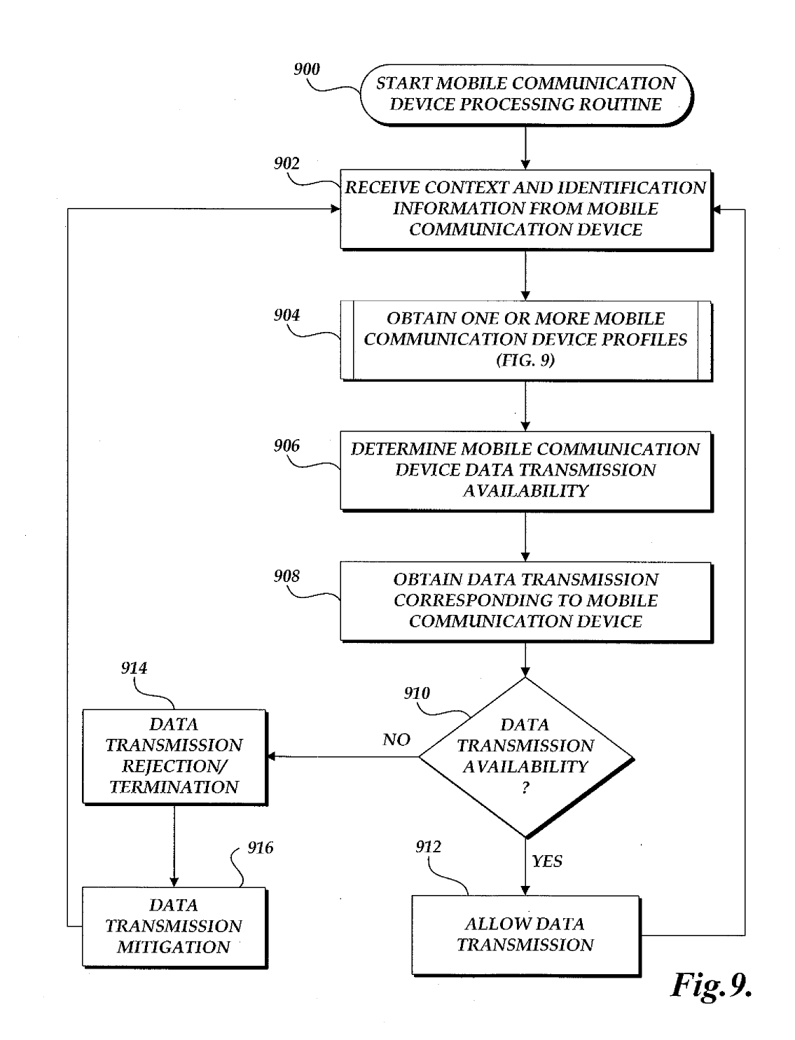

In an additional embodiment, and as illustrated in FIG. 9, the mobile communication device environment interface 306 can associate location meta data with known signals from wireless transmitters such that a detection of a signal can provide an indication to the mobile communication device environment interface 306 of the relative location of a mobile communication device 104. As explained above with regard to routine 700 (FIGS. 7A-7E), as a mobile communication device 104 travels, signals from specific transmitters are detected when the mobile communication device is within range of the transmitter and no longer detected when the mobile communication device is beyond the range of the transmitter. In embodiments in which the mobile device detects signals from the same wireless transmitters, the mobile communication device environment interface 306 can associate location meta data obtained from another location source (such as a GPS component) to the information indicative of the wireless transmitter, such as a WiFi SSID. Accordingly, in conjunction with the known range of the wireless transmitter, the mobile communication device environment interface 306 can estimate range, associate the location meta data as the approximate location of the mobile communication device 104 for purposes of evaluating context according geospatial zones.

For purposes of power consumption, the mobile communication device environment interface 306 can monitor various location sensors/inputs. The mobile communication device environment interface 306 can prioritize or rank the location information sources based on various factors, including degree of confidence in the accuracy of the location information, power consumption associated with collecting the location data, financial or service contract issues, and the like. For example, assume that a mobile communication device environment interface 306 has previously stored location information for a known WiFi wireless node in Meta data in the manner described above. Although location information may also be available for an attached GPS component, operation of the GPS component consumes much more device power. Accordingly, the mobile communication device environment interface 306 could choose to receive/use location information from a source with the least power consumption metrics.

With reference again to FIG. 8, at block 808, the mobile communication device context processing component 304 calculates the distance and bearing of the current location of the mobile device to the centroid of geospatial zone. At decision block 810, a test is conducted to determine whether the distance to the centroid is outside of the maximum radius defined for the geospatial zone. If so, at block 812, the mobile device's current context is outside the geospatial zone. The routine 800 then proceeds to block 818, which will be described below.

If at decision block 810, the distance to the centroid is not outside the maximum radius, the mobile communication device context processing component 304 will then determine whether the mobile communication device is clearly within the geospatial zone or on the fringe of boundary of the geospatial zone. At decision block 814, a test is conducted to determine whether the distance is less than the minimum radius defined for the geospatial zone. If so, at block 816, the mobile device's current context is inside the geospatial zone. The routine 800 then proceeds to block 818.

At block 818, the mobile communication device 104 must transmit updated context information if a context state has changed. Accordingly, if the mobile communication device has not changed from outside the geospatial zone (block 812) or within the geospatial zone (block 816), no update will be provided. At block 820, the interval for collection of location information and the evaluation of the proximity to the geospatial zone will be decreased (or verified to be at a lower level). In either the case of clearly outside the geospatial zone or clearly within the geospatial zone, the likelihood of a sudden change in context decreases. For example, for a geospatial zone corresponding to an entire city, the frequency in which the mobile device would detect a change corresponding to being detected outside the citywide geospatial zone would likely be low. Accordingly, the collection interval could be adjusted in an effort to mitigate power drain associated with the collection and processing of the sensor information. The routine 800 then returns to block 804 for continued collection and processing of the information at the next collection interval.

Turning again to decision block 814, if the distance is not less than the minimum radius defined for the geospatial zone, the mobile communication device 104 is likely just within the boundary of the geospatial zone or just outside the boundary of the geospatial zone. Accordingly, the mobile communication device context processing component 304 can then determine with the mobile communication device 104 falls within or just outside of the geospatial zone. With reference to FIG. 8B, if the determined context is a change from a previous context, at block 822, the updated context information is transmitted to the communication management component 102. At block 824, the collection interval is increased (or verified to be at a higher level). In the case of neither clearly outside the geospatial zone or clearly within the geospatial zone, the likelihood of a sudden change in context increases. Because of the potential for more likely changes in context, the interval for collection is increased. The routine 800 then returns to block 804 (FIG. 8A) for continued collection and processing of the information at the next collection interval.

### Communications Management Component Operation

With reference now to FIG. 9, a routine 900 implemented by the communication processing component 204 to manage communications associated with a mobile communication device 104 will be described. At block 902, the mobile communication device interface component 202 receives mobile communication device context information from the mobile communication device 104. The mobile communication device context and identification information. Illustratively, the mobile communication device context information corresponds to processed inputs and is indicative of the mobile communication device context. The context information may require additional processing by the communication management system 102. As previously discussed, the mobile device communication component 102 may utilize any number of communication channels to receive the context information from the mobile communication device 104. Additionally, in the event that the context information corresponds to updated context information, especially if the mobile communication device is presently in an established communication channel, the mobile device communication component 202 may utilize alternative communication channels.

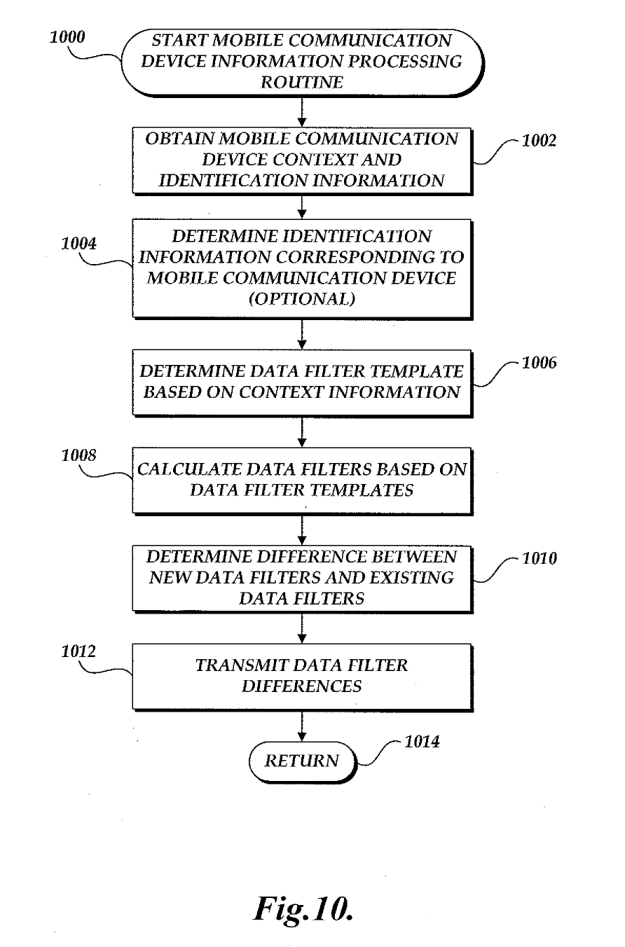

At block 904, the communication management system 102 obtains mobile communication device profile information from the mobile communication device profile store 212. As previously described, the mobile communication profile data store 212 can correspond to a database that identifies different mobile communication device profiles according to different mobile communication device context. For example, a mobile communication device may have a profile of data filtering rules for each defined geospatial region and transit state. An illustrative sub-routine for determining mobile communication device profiles will be described with regard to FIG. 10.

At block 906, the communication management system 102 determines data availability according to the profile information obtained at block 904. The availability information may be determined upon receipt of the context information and/or may be updated upon receipt of updated context information. Additionally, if a communication channel is not already established, the availability is determined prior to receiving a request for establishing a communication channel from either the mobile communication device 104 or a third party computing device 118.

At block 908, the communication management system 102 obtains a data transmission corresponding to the mobile communication device. The data transmission can correspond to data transmissions originated by the mobile communication device 104 or data transmissions directed toward the mobile communication device 104. Still further, the data transmissions can correspond to a new exchange of data between the mobile communication device 104 and another computing device, such as computing device 112. Alternatively, the data transmissions can correspond to existing data transmissions. Illustratively, the data transmissions are processing by individual data packets that include some identification information, such as a destination IP address, transport identifier, and the like.

At decision block 910, the communication management system 102 performs a test to determine whether the mobile communication device is available to receive or transmit data. If the mobile communication device 104 has been determined to be available, at block 912, the communication management system 102 allows the data transmission to occur. The routine 900 returns to block 902.

Alternatively, if it has been determined that mobile communication device 104 is not available to transmit or receive data, at block 914, the communication management system 102 transmits a rejection or termination message, or otherwise mitigates the forwarding of the data packet. At block 916, the communication management system 102 processes the communication mitigation and the routine 900 returns to block 902. Illustratively, the communication mitigation component can correspond to the preservation of the data packets such that they are delivered once the mobile communication device 104 has a different context. In another embodiment, the communication mitigation can correspond to the deletion of packets. In still another embodiment, the communication mitigation can correspond to a special processing of data packets corresponding to VoIP communications. For example, a computing device, such as computing device 118, may be directed to voicemail or hold status while the mobile communication device remains in its current context.

Referring now to FIG. 10, a flow diagram illustrative of a mobile communication device information processing subroutine 100 implemented by the communication management system 102 will be described. As previously described, subroutine 100 may correspond to block 904 (FIG. 9) for obtaining mobile communication device profiles utilized in the determination of data filtering rules. At block 1002, the communication management system 102 obtains mobile communication device context and identification information corresponding to a particular mobile communication device. In an illustrative embodiment, the communication management system 102 obtains both context information and identification information from the mobile communication device 104. Additionally, as illustrated in optional block 1004, the communication management system 102 can also determine additional identification information that corresponds to the mobile communication device 104. As previously discussed, the mobile communication device context information can correspond to one or more context states based on measurements, observations, or processing conducted by the mobile communication device 104. The identification information can correspond to a variety of information that is utilized to identify data communications to or from the mobile communication device 104.

At block 1006, the communication management system 102 determines data filter templates corresponding to the context information. In an illustrative embodiment, the data filter templates define one or more actions to be taken based on context states. As previously described, the actions can include allowing data packet communications, denying or rejecting data packets, dropping data packets, delaying data packets, diverting data packets and the like. The data filter templates will be applied to the identification information. At block 1008, the communication management system 102 determines data filters to be used by the data processing component 208 (FIG. 2) for processing data packets.

At block 1010, in the event that one or more data filer rules already exist, the communication management system 102 can determine differences between the existing rules and the data filtering rules determined at block 1008. Illustratively, the data differences can be used to generate updates, patches, modifications, supplements, etc. to the existing data filtering rules. At block 1012, the communication management system 102 transmits (or implements) the data filter differences to implement the data filtering rules. At block 1014, the sub-routine 1000 returns. One skilled in the art will appreciate that blocks 1012 and 104 may be omitted and that any data filtering rules can be overwritten, deleted, etc. Additionally, if no previous data filtering rules exist, blocks 1012 and 1014 may not be implemented.

While illustrative embodiments have been disclosed and discussed, one skilled in the relevant art will appreciate that additional or alternative embodiments may be implemented within the spirit and scope of the present disclosure. Additionally, although many embodiments have been indicated as illustrative, one skilled in the relevant art will appreciate that the illustrative embodiments do not need to be combined or implemented together. As such, some illustrative embodiments do not need to be utilized or implemented in accordance with the scope of variations to the present disclosure.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored on a computer-readable medium and loaded into memory of the computing device using a drive mechanism associated with a computer-readable medium storing the computer executable components, such as a CD-ROM, DVD-ROM, or network interface. Further, the component and/or data can be included in a single device or distributed in any manner. Accordingly, general purpose computing devices may be configured to implement the processes, algorithms and methodology of the present disclosure with the processing and/or execution of the various data and/or components described above. Alternatively, some or all of the methods described herein may alternatively be embodied in specialized computer hardware. In addition, the components referred to herein may be implemented in hardware, software, firmware or a combination thereof.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computer-implemented method, comprising:
receiving context change notification messages transmitted by a mobile communications device, at least some of said context change notification messages based on motion-based context assessments performed by the mobile communications device;
maintaining state data in computer storage based, at least in part, on the received context change notification messages, wherein the state data is maintained and updated in said computer storage at least during time periods in which the mobile communications device is not being used by the user, said computer storage being separate from the mobile communications device and wherein the state data includes mobile communication device identification information associated with data communications associated with the mobile communication device;
in response to an incoming request data request, using at least said state data, as maintained in said computer storage prior receipt of said request, to determine, at least, whether to perform an action on the data request as specified in the state data;
receiving updated context change notification messages corresponding to the mobile communications device;
associating the mobile communications device with updated state data, the updated state data; and
in response to a second incoming data request, using at least the updated state data, as maintained in said computer storage prior receipt of said request, to determine, at least, whether to perform an action on the data request as specified in the state data.

2. The computer-implemented method as recited in claim 1, wherein receiving updated context change notification messages corresponding to the mobile communications device includes receiving updated context change notification messages corresponding to the mobile communications device from the mobile communications device.

3. The computer-implemented method as recited in claim 1, wherein receiving updated context change notification messages corresponding to the mobile communications device includes receiving updated context change notification messages corresponding to the mobile communications device from a network node.

4. The computer-implemented method as recited in claim 1, wherein using at least said state data to determine whether to perform an action on the data request includes determining whether to at least one of reject, deny or drop data packets corresponding to the data request.

5. The computer-implemented method as recited in claim 4 further comprising mitigating the data requests based on a determination to at least one of reject, deny or drop data packets corresponding to the data request.

6. The computer-implemented method as recited in claim 5, wherein mitigating the data requests includes maintaining at least a portion of the data packets.

7. The computer-implemented method as recited in claim 5, wherein mitigating the data requests includes diverting at least a portion of the data packets.

8. The computer-implemented method as recited in claim 5, wherein mitigating the data request includes queuing at least a portion of the data packets.

9. The computer-implemented method as recited in claim 1, wherein the mobile communication device identification information includes an Internet Protocol address assigned to the mobile communication device.

10. The computer-implemented method as recited in claim 1, wherein the mobile communication device identification information includes identification assigned to the mobile communication device.

11. The computer-implemented method as recited in claim 10, wherein the identification assigned to the mobile communication device is selected from one of transport information, mobile identification number, international mobile subscriber identity information, network access identifier information, and session initiated protocol address information.

12. The computer-implemented method as recited in claim 1, wherein the mobile communication device identification information includes identification assigned to a user associated with mobile communication device.

13. A system for managing communications associated with a mobile communication device comprising:
a mobile communication device interface for bilateral communications with a mobile communication device, wherein the mobile communication device interface obtains mobile communication device context information;
a mobile communication device data store for maintaining mobile communication device availability profiles according to specific mobile communication device contexts, wherein the mobile communication device availability is determined asynchronously to communication requests and includes information for identifying data communications designated for the mobile communication device; and
a communication management component for managing data communications between a mobile communication device and another device based on the mobile communication device profiles, wherein managing data communications includes determining whether to perform an action on the data request as specified in the availability profiles.

14. The system as recited in claim 13, wherein the mobile telecommunications device can be associated with two or more mobile communication device contexts.

15. The system as recited in claim 13, wherein the communication management component is further operable to receive further updated context change notification messages corresponding to the mobile communications device and associate the mobile communications device with updated availability profiles, the updated availability profiles at least reflecting a different determination of whether to perform an action on the data request as specified in the availability profiles.

16. The system as recited in claim 13, wherein the communication management component is operable to determine whether to at least one of reject, deny or drop data packets corresponding to the data request.

17. The system as recited in claim 16, wherein the communication management component is further operable to mitigate data requests based on a determination to at least one of reject, deny or drop data packets corresponding to the data request.

18. The system as recited in claim 17, wherein the communication management component mitigates data request by maintaining at least a portion of the data packets.

19. The system as recited in claim 17, wherein the communication management component mitigates data request by diverting at least a portion of the data packets.

20. The system as recited in claim 17, wherein the communication management component mitigates data request by queuing at least a portion of the data packets.

21. The system as recited in claim 13, wherein the mobile communication device identification information includes an Internet Protocol address assigned to the mobile communication device.

22. The system as recited in claim 13, wherein the mobile communication device identification information includes identification assigned to the mobile communication device.

23. The system as recited in claim 22, wherein the identification assigned to the mobile communication device is selected from one of transport information, mobile identification number, international mobile subscriber identity information, network access identifier information, and session initiated protocol address information.

24. A method for managing communications associated with a mobile communication device comprising:
maintaining a mobile communication device profile, wherein the mobile communication device profile defines criteria for processing data processing profiles based on a current mobile communication device context and identification information attributed to a mobile communication device;
prior to a data request associated with a mobile communication device, determining data filtering rules reflective of an unavailability of the mobile communication device based on processing current mobile communication device context information with the mobile communication device profile, wherein the mobile communication device availability is an assessment of a desirability of facilitating data communications;
subsequently managing data communication requests between the mobile communication device and another communication device, wherein managing communications includes determining whether to perform an action on data packets associated with the data communications based on the data filtering rules;
receiving updated context change notification messages corresponding to the mobile communications device;
determining an updated set of data filtering rules reflective of an unavailability of the mobile communication device based on processing the updated mobile communication device context information; and
in response to a second incoming data communication request, determining whether to perform an action on data packets associated with the data communications based on the updated data filtering rules.

25. The method as recited in claim 24, wherein determining whether to perform an action on the data request includes determining whether to at least one of reject, deny or drop data packets corresponding to the data request.

26. The method as recited in claim 25 further comprising mitigating the data requests based on a determination to at least one of reject, deny or drop data packets corresponding to the data request.

27. The method as recited in claim 24, wherein determining an updated set of data filtering rules reflective of an unavailability of the mobile communication device based on processing the updated mobile communication device context information includes determining a difference between the set of data filtering rules and the updated set of data filtering rules.

28. The method as recited in claim 27 further comprising updating the set of data filtering rules based on the determined difference between the set of data filtering rules and the updated set of data filtering rules.
